(19) United States
(12) Patent Application Publication
(10) Pub. No.: US 2007/0198870 A1
(43) Pub. Date: Aug. 23, 2007

(54) METHOD FOR CONTROLLING POWER CONSUMPTION AND MULTI-PROCESSOR SYSTEM USING THE SAME

(75) Inventors: Hown Cheng, Taipei City (TW); Yan Wu, San Jose, CA (US); Weisung Tsao, San Jose, CA (US); Wei-Lung Chang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ITE TECH. INC., Hsinchu (TW)

(21) Appl. No.: 11/461,440

(22) Filed: Jul. 31, 2006

(30) Foreign Application Priority Data
Feb. 20, 2006 (TW) 95105607

(51) Int. Cl. G06F 1/00

(52) U.S. Cl. 713/500

(57) ABSTRACT

A multi-processor system comprises a clock generator, a clock controller, a main processor, a plurality of co-processors and an interrupt control interface. Because the main processor and the co-processors need not work together to deliver the processing result, the multi-processor system may be designed that each processor in the multi-processor system is independently switched to operate at lower clock or power down completely according to the feedback of the hardware performance detection for each processor when the whole system is in active usage. This means on-demand power saving for the multi-processor system, so as to save power greatly.

### CROSS-REFERENCE TO RELATED APPLICATION

This application claims the priority benefit of Taiwan application serial no. 95105607, filed Feb. 20, 2006. All disclosure of the Taiwan application is incorporated herein by reference.

### BACKGROUND OF THE INVENTION

1. Field of Invention

The present invention relates to a power saving technology. More particularly, the present invention relates to a method for controlling the power consumption for the multi-processor system and a multi-processor system using the method.

2. Description of Related Art

Nowadays, the integrated circuit has been widely applied in electronic devices. For example, there are integrated circuits in personal computer (PC), mobile phone, optical disc player, MP3 player, etc. These integrated circuits comprise many circuits with specific functions, and these circuits are mostly composed of transistors. It is well known that the transistor performance (for example, transfer characteristics, on resistance, slew rate, etc.) is related to the power supply. That is, the transistor performance is low when the power is low, whereas, the transistor performance is high when the power is high.

However, power saving has become more and more important as a result of the prevalence of the battery-depended hand-held devices and the environment protection conception of power saving. In order to save power and maintain acceptable performance, many power saving technologies for integrated circuit have been disclosed, for example, the power saving technologies disclosed in U.S. Pat. No. 6,366,522, U.S. Pat. No. 5,392,437, U.S. Pat. No. 5,546,568 and U.S. Pat. No. 5,825,674. However, all of the power saving technologies mentioned above focus on how to detect and minimize the power consumption when part of circuit is inactive, for example to provide a power-down mode; or focus on lowering the clock speed of the central processing unit (CPU) when part of the circuit is in idle mode, e.g., clock gating.

### SUMMARY OF THE INVENTION

Accordingly, the present invention is directed to providing a multi-processor system such as a system-on-chip (SoC). The system can independently control the power consumption of each processor when the entire system is still in active usage, so as to save power.

The present invention is to provide a method for controlling the power consumption. The method is suitable for a multi-processor system such as a SoC, which can independently control the power consumption of each processor when the entire system is still in active usage so as to save power.

The present invention provides a multi-processor system, comprising a clock generator, a clock controller, a main processor, a plurality of co-processors and an interrupt control interface. Wherein, the clock generator generates a plurality of clock signals with different speeds. The clock controller selects one clock signal from these clock signals as a first clock signal in respond to a corresponding first control signal, and selects multiple clock signals from these clock signals as a plurality of second clock signals in respond to a corresponding plurality of second control signals. Using the first clock signal as the operation clock of the main processor, the main processor outputs the first control signal according to the hardware performance of the main processor, wherein the clock controller is disabled when a disable signal outputted from the main processor is active (for example, the disable signal is active when its voltage level is logic high). Using the second clock signals as the operation clocks of the co-processors respectively, the co-processors output the second control signals according to the hardware performance of the co-processors respectively, wherein each co-processor assists the main processor to perform a specific function operation, such as the operation of floating-point calculation, graphic processing or data coding/decoding. The interrupt control interface is coupled among the main processor, the co-processors and the clock controller to receive an interrupt signal outputted from the main processor, at least one of the co-processors or the clock controller, so as to perform a corresponding interrupt operation.

The present invention further provides a method for controlling the power consumption, which is suitable for the multi-processor system with a plurality of co-processors. In the method, one of the co-processors is operated at a speed. The co-processor (i.e. above-mentioned one of the co-processors) is switched to idle when the hardware performance of the co-processor is detected that the task has been completed. The co-processor is switched to operate at a different speed when the hardware performance of the co-processor is detected that part of the task has been completed, wherein the first speed is faster than the second speed. The co-processor is switched to be idle when the co-processor is operated at the second speed and the hardware performance of the co-processor is detected that the task has been completed. The co-processor is switched to operate at the first speed when the co-processor is operated at the second speed and the hardware performance of the co-processor is detected that the task increases. The co-processor is switched to operate at the first speed when the co-processor is idle and receives an interrupt signal.

According to the present invention, because the main processor and the co-processors need not work together to deliver the processing result, each processor in the multi-processor system can be independently switched to operate at lower clock or power down completely according to the feedback of the hardware performance detection for each processor when the whole system is in active usage, accordingly, the power can be saved greatly.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a multi-processor system according to one embodiment of the present invention.

FIG. 2 is a flow chart of the method for controlling the power consumption according to one embodiment of the present invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

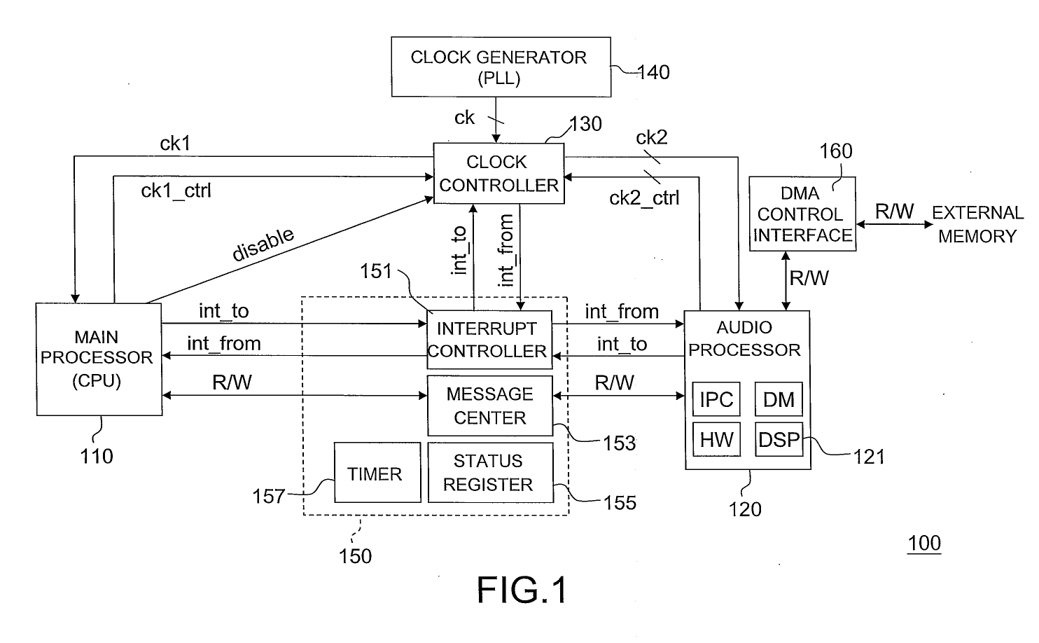

FIG. 1 is a schematic block diagram of a multi-processor system according to one embodiment of the present invention. Referring to FIG. 1, the processor of the multi-processor system 100 comprises a main processor 110 and a co-processor 120. For example, the main processor 110 is a central processor unit (CPU), and the co-processor 120 is an audio processor and/or a video processor. The co-processor 120 is just described as an audio processor herein, comprising a plurality of co-processors DSP, HW, DM and IPC.

In the multi-processor system, the co-processors perform the specific functions that the main processor (for example, CPU) can not perform or can not perform quickly and well. The operations performed by the co-processors may include the operations of float-point calculation, graphic processing and data coding/decoding, etc. Although the main processor can perform these functions, the co-processors can perform these functions more quickly, so that the system performance can be improved. The co-processor may be not the general-purpose processor. Some of these co-processors can not access commands form the memory unit, perform control commands of the program flow, perform output/input operation or manage the memory unit, etc. These co-processors need the main processor to access the commands of the co-processors and perform other operations except for the co-processor functions. In some architectures, the co-processor is the general-purpose processor, and has only limited functions under the monitor and control of the main processor.

According to the embodiment, besides the processors 110 and 120, the multi-processor system 100 further comprises a clock controller 130, a clock generator 140 and an interrupt control interface 150. The interrupt control interface 150 comprises an interrupt controller 151, a message center 153, a status register 155, and a timer 157, wherein the status register 155 is suitable to register the status of output buffers, input buffers and middle buffers in the multi-processor system, and the timer 157 is used to count so as to stop the interrupt operation.

The main processor (CPU) 110 provides the compressed music file to the co-processor (audio processor) 120. It includes the following steps: the CPU 110 detects the type and parameter of the compressed music file; the compressed music file is read into the audio processor 120 from, for example, an external memory in real time by using the direct memory access (DMA) control interface 160; and the decoded PCM file is delivered to the audio decoder of the audio processor 120 to be decoded so as to play the music. The CPU 110 also responds user's real-time request, such as the volume adjustment or forward play, pause, etc.

The clock generator 140 is suitable for generating various clock signals ck with different speeds, usually using the phase-lock loop (PLL) to generate accurate clock. According to the feedback of the first control signal ck1_ctrl from the CPU 110, the clock controller 130 selects the clock signal ckl from the clock signals ck generated by the clock generator 140 as the operation clock of the CPU 110. According to the feedback of the second control signal ck2_ctrl from the audio processor 120, the clock controller 130 selects the clock signals ck2 from the clock signals ck generated by the clock generator 140 as the operation clocks of the audio processor 120. Wherein the clock signal ck2 may comprise a plurality of clock signals with different speeds so as to be respectively provided to each processor DSP, HW, DM and IPC of the audio processor 120.

For example, when the CPU 110 intends to inform its status to the audio processor 120, the CPU 110 may first output an interrupt signal int_to to the interrupt controller 151, and store its data into the message center 153 after obtaining the control of the message center 153. After receiving the interrupt signal int_from from the interrupt controller 151, the audio processor 120 can obtain the dynamic data about the CPU 110 from the message center 153. After completing the above processes, the CPU can determine whether to switch into lower or even stagnant clock signal according to the hardware performance detection device (not shown). That is, the first control signal ck1_ctrl is sent to the clock controller 130 according to the judgment of the hardware performance detection device; then, the clock controller 130 outputs a first clock signal ckl so as to provide the lowest or suitable operation clock to the CPU 110.

Vice versa, when an unexpected request comes, the audio processor 120 can use the mechanism to wake the CPU 110 up. For example, when the audio processor 120 is decoding the audio streams and its output buffer has been full and the current buffer is still not cleared, the audio processor 120 can output an interrupt command int_to to the interrupt controller 151 so as to provide its data to the CPU 110, then output the second control signal ck2_ctrl according to the judgment of the hardware performance detection device, so as to adjust its own operation clock (i.e., the second clock signal ck2) by the clock controller 130. Wherein, the hardware performance detection device comprises some small sense circuits and software, which selects the clock intelligently according to some data such as the status of input buffers, output buffers or middle buffers in the status register 155. Moreover, if needed, the CPU 110 can disable the clock controller 130 to perform the switch of the clock signal by setting the disable signal ‘disable’ active, or disable the hardware performance detection device directly.

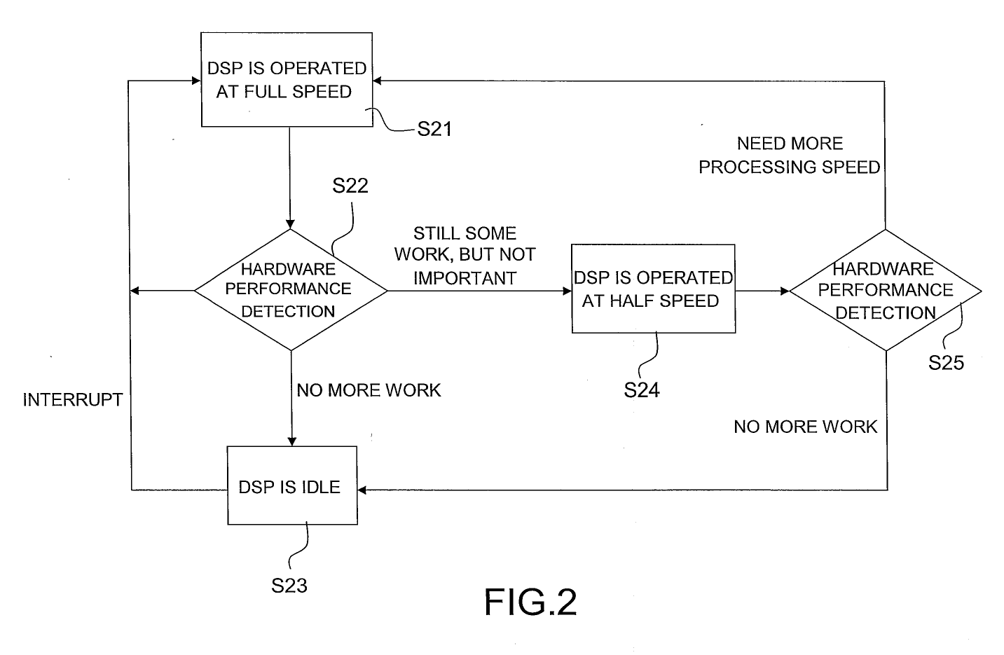

FIG. 2 is a flow chart of the method for controlling the power consumption according to one embodiment of the present invention. Referring to FIG. 1 and FIG. 2 simultaneously, the digital signal processor (DSP) 121 in FIG. 1 is taken as the example here. When the DSP 121 acts as a co-processor when retrieving the command from the main processor 110 and starting the calculation cycle of the task, all of the input and output data come from internal storage. And, the input and output of the actual data of the entire system is completed by the DMA control interface 160.

In the process S21, the DSP 121 is operated at full speed. In the process S22, if the hardware performance detection device detects that the DSP 121 has completed the task (i.e. no more work), the DSP 121 would be idle in the process S23; if the hardware performance detection device detects that the DSP 121 has completed most of the task and only some unimportant task is left (i.e. still some work, but not important), the DSP 121 would be operated at half speed in the process S24; in other occasions, the DSP 121 would still be operated at full speed. In the process S25, if the hardware performance detection device detects that the DSP 121 has completed the task, the DSP 121 would be idle in the process S23; if the hardware performance detection device detects that the DSP 121 needs more processing speed, the DSP 121 would return to the process S21 to operate at full speed. If there is any change of the status and other part of the system detects the change, an interrupt signal int_to would be sent to the message center 153. In the process S23, the DSP 121 is idle, and the interrupt controller 151 needs to output an interrupt signal int_from to wake it up.

In summary, the multi-processor system of the present invention is designed that each processor in the multi-processor system can be independently switched to operate at lower clock or power down completely according to the feedback of the hardware performance detection for each processor when the whole system is in active usage. For example, each processor can operate at full speed, half speed or idle, so that the power can be saved greatly. The reason is that the main processor and the co-processors need not work together to deliver the final result, so that the operation clock of each processor can be independently controlled, and the performance of the whole system would not be compromised. This means on-demand power saving for the multi-processor system-on-chip.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multi-processor system, comprising:
a clock generator for generating a plurality of clock signals with different speeds;
a clock controller for selecting one clock signal from the clock signals as a first clock signal in respond to a corresponding first control signal, and selecting multiple clock signals from the clock signals as a plurality of second clock signals in respond to a corresponding plurality of second control signals;
a main processor, using the first clock signal as the operation clock of the main processor, for outputting the first control signal according to the hardware performance of the main processor, wherein the clock controller is disabled when a disable signal outputted from the main processor is active;
a plurality of co-processors, using the second clock signals as the operation clocks of the co-processors respectively, for outputting the second control signals according to the hardware performances of the co-processors respectively, wherein each of the co-processors assists the main processor to perform a specific function operation; and
an interrupt control interface coupled among the main processor, the co-processors and the clock controller, for receiving an interrupt signal outputted from the main processor, at least one of the co-processors or the clock controller, and performing a corresponding interrupt operation.

2. The multi-processor system as claimed in claim 1, wherein the multi-processor system includes a system-on-chip (SoC).

3. The multi-processor system as claimed in claim 1, wherein the main processor includes a central processor unit (CPU).

4. The multi-processor system as claimed in claim 1, wherein the co-processors form an audio processor and/or a video processor.

5. The multi-processor system as claimed in claim 1, wherein the interrupt control interface comprises:
an interrupt controller for receiving the interrupt signal outputted from the main processor, at least one of the co-processors or the clock controller, and performing the corresponding interrupt operation;
a message center for transmitting the status of the main processor and at least one of the co-processors;
a status register for registering the status of output, input and middle buffers in the multi-processor system; and
a timer for counting so as to stop the corresponding interrupt operation.

6. The multi-processor system as claimed in claim 1, further comprising a direct memory access (DMA) control interface for communicating between the co-processors and external data.

7. A method for controlling the power consumption for a multi-processor system with a plurality of co-processors, the method comprising:
one of the co-processors is operated at a first speed;
the co-processor is switched to be idle when the hardware performance of the co-processor is detected that the task has been completed;
the co-processor is switched to operate at a second speed when the hardware performance of the co-processor is detected that part of the task has been completed, wherein the first speed is faster than the second speed;
the co-processor is switched to be idle when the co-processor is operated at the second speed and the hardware performance of the co-processor is detected that the task has been completed;
the co-processor is switched to operate at the first speed when the co-processor is operated at the second speed and the hardware performance of the co-processor is detected that the task increases; and
the co-processor is switched to operate at the first speed when the co-processor is idle and receives an interrupt signal.

8. The method for controlling the power consumption as claimed in claim 7, wherein the multi-processor system includes a system-on-chip (SoC).

9. The method for controlling the power consumption as claimed in claim 7, wherein the first speed is a full speed, and the second speed is a half speed.
